(19) United States
(12) Patent Application Publication
(10) Pub. No.: US 2018/0232647 A1
(43) Pub. Date: Aug. 16, 2018

(54) DETECTING CONVERGENCE OF ENTITIES FOR EVENT PREDICTION

(71) Applicant: International Business Machines Corporation, Armonk, NY (US)

(72) Inventors: Richard M. Appleby, Hampshire (GB); Trinette A. Brownhill, Montgomery, TX (US); James S. Luke, Hampshire (GB); Jean-Francois Puget, SAINT RAPHAEL (FR); John A. Ricketts, Lakeville, MN (US)

(21) Appl. No.: 15/429,361

(22) Filed: Feb. 10, 2017

(51) Int. Cl. G06N 7/00; G06F 9/54

(52) U.S. Cl. CPC G06N 7/005; G06F 9/542

(57) ABSTRACT

A method, and associated computer system and computer program product. Tracking data relating to movement of two or more entities associated with individuals over a past time period is received. A vector is determined for predicted movement of each entity of the two or more entities over a future time period based on at least part of the received tracking data. A determination is made as to whether a first vector for predicted movement of an entity associated with a first individual is converging in time and space with a second vector for predicted movement of an entity associated with a second individual. An event involving the first and second individuals is predicted in response to determining a convergence of the first and second vectors.

### TECHNICAL FIELD

The present invention relates to event prediction, and more specifically, to the prediction of events based on detecting a convergence of entities in time and space.

### BACKGROUND

Entities such as law enforcement and intelligence agencies may wish to know the location of meetings where suspicious activities are being carried out so that the entities may better observe or disrupt the meetings. Often however, the entities will only have incomplete information about such meetings, making an ability of the entities to detect the meetings much more difficult.

### SUMMARY

The present invention provides a method, and associated computer system and computer program product. One or more processors of the computer system receive tracking data relating to movement of a plurality of entities associated with individuals over a past time period. The one or more processors determine a vector for predicted movement of each entity of the plurality of entities over a future time period based on at least part of the received tracking data. The one or more processors determine whether a first vector for predicted movement of an entity associated with a first individual is converging in time and space with a second vector for predicted movement of an entity associated with a second individual. The one or more processors predict an event involving the first and second individuals in response to determining a convergence of the first and second vectors.

### BRIEF DESCRIPTION OF THE DRAWINGS

Example implementations of the present invention will be described below with reference to the following drawings.

FIG. 1 is a block diagram of a system according to an example implementation of the present invention.

FIG. 2 is a flowchart of a method for event prediction according to an example implementation of the present invention.

FIGS. 3 to 9 are schematic diagrams illustrating techniques for detecting convergence according to example implementations of the present invention.

FIG. 10 is a block diagram of a system for processing data and predicting an event, such as a meeting, according to an example implementation of the present invention.

### DETAILED DESCRIPTION

The following description relates to the prediction of future meetings between two or more people (herein called “individuals”) at a particular time and at a particular geographical location. As the skilled person will appreciate, the described techniques may be used in predicting other types of events in which multiple individuals come together. The described system receives time and location data relating to movement of entities associated with individuals. The system receives data relating to movement of entities originating from a variety of sources and predicts meetings between individuals based on detecting a predicted convergence of the entities in time and space. In the following description, the term “entities” includes devices, apparatus and equipment associated with individuals (e.g., vehicles and mobile devices) and also the individuals themselves. In addition, the term “location” refers to a physical or geographic location in space, and the term “time” refers to a point in time at the particular location (e.g., a time and date in a relevant time zone). Unless otherwise stated, references to “time” and “space” include time and location ranges.

Example implementations of the present invention relate to a system comprising sub-systems and/or processing modules (e.g., software, firmware and/or hardware) that receive and process data relating to time and location of moving entities associated with individuals. The data (herein called “location tracking data” or simply “tracking data”) may be received from a variety of data sources over a data communications network. As the skilled person will appreciate, tracking data may originate from a variety of primary data sources and may be received, by the system, from a secondary data source, such as a data warehouse, where tracking data from primary data sources may be collected, stored and collated. As the skilled person will appreciate, the described techniques may obtain tracking data from any suitable source. In the drawings, the same or similar features are assigned the same or similar reference numerals.

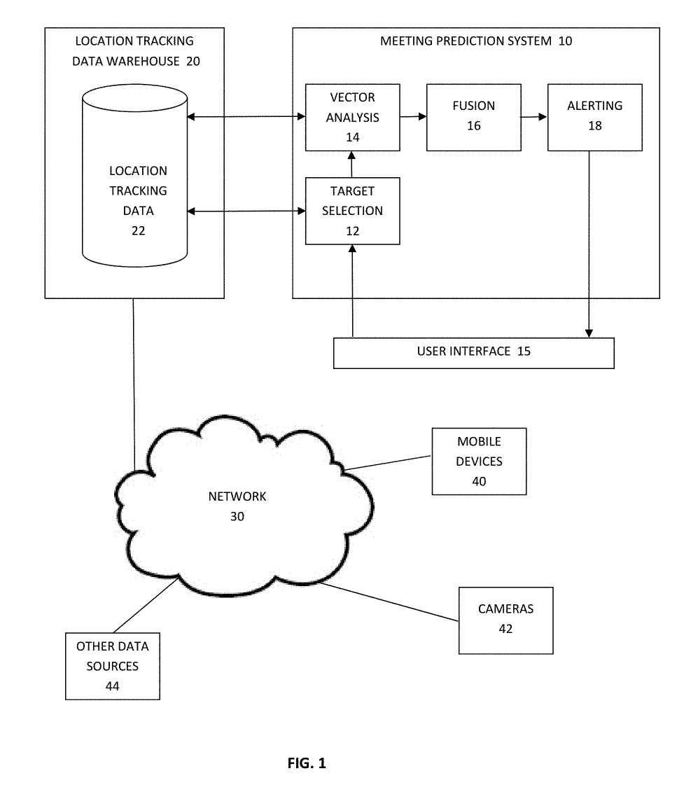

FIG. 1 is a block diagram of a system according to an example implementation of the present invention. In particular, the illustrated system comprises a meeting prediction system 10 having a plurality of subsystems including a target selection subsystem 12, a vector analysis subsystem 14, a fusion subsystem 16 and an alerting subsystem 18. Meeting prediction system 10 also includes a user interface 15 for receiving input data from users and providing output data to users, for example by displaying data in a GUI on a display screen of the user interface 15. The meeting prediction system 10 further comprises a location tracking data warehouse 20, which receives and processes data from one or more primary data sources of mobile device 40, cameras 42, and other data sources 44, over a data communication network 30. Meeting prediction system 10 is in data communication with the location tracking data warehouse 20 to receive tracking data therefrom, as described further below.

Primary data sources may include mobile devices 40 associated with individuals, such as cellular telephones, personal digital assistants (PDAs), mobile computers or other portable user devices capable of communication over a wireless communication network and from which time and location data may be obtained. In addition, primary data sources may include cameras 42, such as CCTV cameras and traffic enforcement cameras, for capturing images of individuals (who may be identified, for example, by face recognition technology) or vehicles (which may be identified, for example, by automatic license plate recognition (ALPR) systems) associated with individuals, from which time and location data for individuals and/or vehicles may be obtained. In addition, primary data sources may include other data sources 44. Other data sources 44 may comprise data sources relating to vehicles associated with individuals, such as vehicle entry systems, tollway transponders, vehicle telemetry systems and navigation systems that communicate data to a central server. Other data sources 44 may further comprise data sources relating to individuals, such as entry systems that use ID cards or other means to identify individuals, telephone call data recording systems and IP address/computer login recording systems, which may provide time data for an individual at a fixed location. Primary data sources may also include social media sources (e.g., websites such as Twitter, Facebook, Instagram etc.), which may provide text and/or image information about individuals, from which time and location data for such individuals may be obtained (e.g., from embedded geotags in images).

Location tracking data warehouse 20 comprises a database 22 of location tracking data, which may be collected from one or more of the primary data sources 40, 42 and 44. As the skilled person will appreciate, location tracking data warehouse 20 may collect data from the one or more primary data sources 40, 42 and 44 at periodic intervals, substantially in real time as a data feed, upon request or otherwise, according to design requirements. Suitable databases for collecting, storing and providing tracking data are known in the art, and so will not be described in detail herein. An example database 22 for collecting and storing tracking data is the IBM® i2® Enterprise Insight Analysis solution available from IBM Corporation.

According to the example implementation of the present invention illustrated in FIG. 1, location tracking data warehouse 20 may provide tracking data from database 22 to the vector analysis subsystem 14 of the meeting prediction system 10. The tracking data may be received by the meeting prediction system 10 at periodic intervals, substantially in real time (e.g., as a real time data feed), upon request or otherwise, according to design requirements. The tracking data typically comprises an entity identification data field, a location data field and a time data field. The entity identification data field comprises data including an identifier that uniquely identifies the entity (e.g., a mobile device, vehicle, individual etc.), the location data field comprises data that identifies a physical or geographical location (e.g., latitude and longitude coordinates or equivalent), and the time data field comprises data that identifies a time (e.g., time and date at a particular location).

In addition, the user of user interface 15 may provide target selection data comprising data that identifies or characterizes target entities (e.g., individuals of interest, their vehicles or mobile devices), as inputs to target selection subsystem 12 of meeting prediction system 10. For example, the target selection data may identify a group of target individuals or entities by specifying the identities of the individuals or entities in the group. The target selection data may further specify the identities of different combinations of entities associated with one or more individuals in the group. Alternatively, the target selection data may identify a group of individuals or entities by specifying a characteristic of the individuals or entities in the group. An example characteristic may be a known association or organization to which multiple individuals belong and the characteristic may identify the association or organization. As the skilled person will appreciate, other types of characteristic of an entity or individual are possible and contemplated by the present invention. Furthermore, as well as including constraints relating to target entities, the target selection data may include other types of user-specified target constraints. For example, the target selection may identify locations, or characteristics of locations (e.g., type of venue), and/or may identify times for predicted meetings. As the skilled person will appreciate, the target selection data may include any combination of entity, location, time and other constraints to define a target group, which are chosen by the user according to requirements.

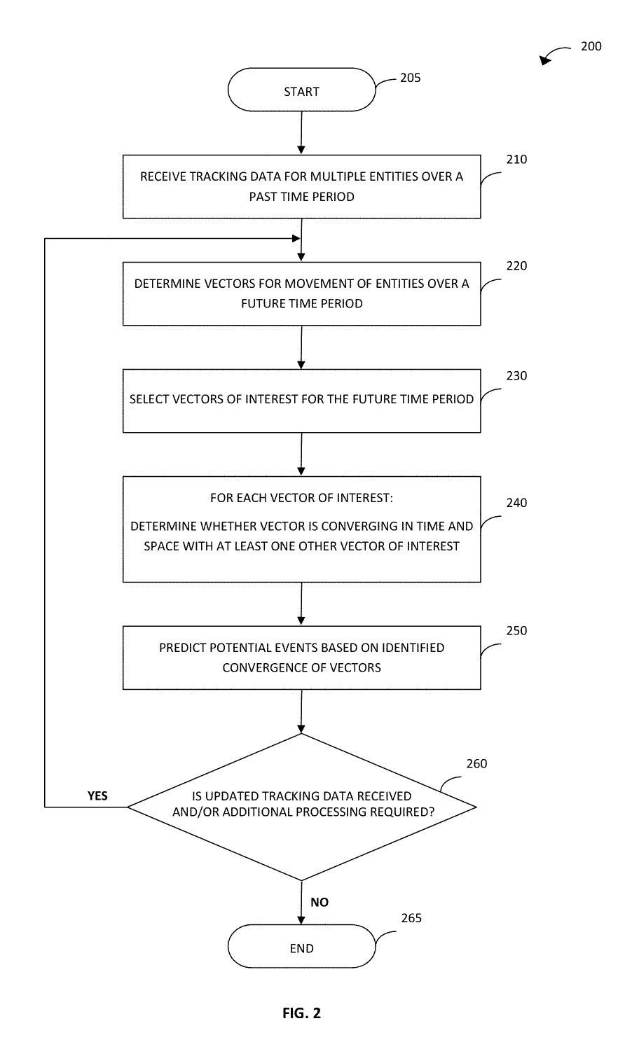

Vector analysis subsystem 14 determines whether a meeting is likely to take place, for example, between individuals within a target group. In particular, vector analysis subsystem 14 receives, as inputs, tracking data from location tracking database 22 and target selection data from target selection subsystem 12 and performs processing, as described below with reference to FIGS. 2 to 9. Vector analysis subsystem 14 provides, as outputs, data identifying predicted meetings between multiple target individuals, based on corresponding vectors of interest that are considered to be converging in time and space, as described in more detail below. The predicted meeting data, output by the vector analysis subsystem 14, typically comprises a group identification data field, comprising data that identifies the group of entities to which the predicted meeting relates, and a location data field and a time data field, comprising data that respectively identifies the location and time of the predicted meeting.

Outputs of vector analysis subsystem 14 are provided to fusion subsystem 16. Fusion subsystem 16 determines whether multiple outputs of the vector analysis subsystem 14 relate to a single meeting, and combines the outputs accordingly. For example, a user may input selection data to target selection subsystem 12 specifying two members of a particular organization, in order to predict the likelihood of a meeting between any two individuals, who are members of the organization. The target selection subsystem 12 may create multiple groups for every combination of two individual members of the specified organization. The vector analysis subsystem 14 performs analysis of tracking data relating to movements of associated entities for each group of two individuals and predicts whether a meeting is likely to take place between each group. Thus, if four members (A-D) of the same organization are actually meeting, then the vector analysis subsystem 14 should identify convergence of at least six separate groups of two individuals (EntityA-EntityB, EntityA-EntityC, EntityA-EntityD, EntityB-EntityC, EntityB-EntityD, EntityC-EntityD).

Thus, the vector analysis subsystem 14 will provide six separate outputs comprising predicted meeting data relating to six ostensibly separate meetings. Thus, providing the outputs of the vector analysis system 14 directly to the user may not allow the user to immediately recognize that the outputs relate to a single meeting. In consequence, the user may expend time and resources investigating six potential predicted meetings instead of just one. Accordingly, fusion subsystem 16 identifies that multiple outputs of predicted meeting data relate to a single meeting involving multiple groups of entities, for example based on a similarity of the time and location data fields, and combines the multiple outputs to form a single output. For example, fusion subsystem 16 identifies that the above six outputs relating to predicted meetings of six groups of two entities associated with individuals, represent a single meeting involving four individuals and combines the six outputs from the vector analysis subsystem 14 to form a single or fused output of the fusion subsystem 16 comprising fused predicted meeting data relating to a single predicted meeting. The fused predicted meeting data output by the fusion subsystem 16 may comprise the same data fields as the predicted meeting data output by the vector analysis subsystem 14, and may include additional data fields, according to design requirements.

As the skilled person will appreciate, in other example implementations, the fusion subsystem 16 may be omitted. However, the use of the fusion subsystem 16 in the example implementation of FIG. 1 enables the user to specify small groups (e.g., pairs) of entities for improved meeting prediction. In particular, in the above example, the user could specify all four entities (individuals A-D) as a group in the target selection data, but the downside of specifying a larger number of entities in a group is that if one individual were not actually attending the meeting, the vector analysis subsystem 14 would not identify the meeting between the other three individuals. Identifying meetings between small groups, such as pairs of entities, in the target analysis subsystem 14 ensures that at least most, if not all, potential meetings of interest are identified in the predicted meeting outputs, while fusing the outputs in the fusion subsystem 16 ensures that the user is provided with a fused output relating to the same meeting involving all of the individuals.

Returning to FIG. 1, fusion subsystem 16 provides outputs comprising fused predicted meeting data and predicted meeting data relating to separate predicted meetings to alerting subsystem 18 of meeting prediction system 10. Alerting subsystem 18 generates appropriate periodic or real time alerts as notifications to user interface 15 for alerting the user of the predicted meetings. Any suitable technique for alerting the user via user interface 15 may be used, according to design requirements.

FIG. 2 is a flowchart of a method 200 according to an example implementation of the present invention. In particular, although not exclusively, the method 200 may be performed by the meeting prediction system 10 including, for example, the vector analysis subsystem 14 of FIG. 1, as described above.

The method 200 starts at step 205. At step 210, the method receives tracking data for multiple entities associated with individuals over a past time period. As described above in relation to FIG. 1, tracking data comprising time and location data for an entity (e.g., mobile device, vehicle or individual) may be received from a database at periodic intervals, in real time (e.g., as real time data feeds), upon request or otherwise.

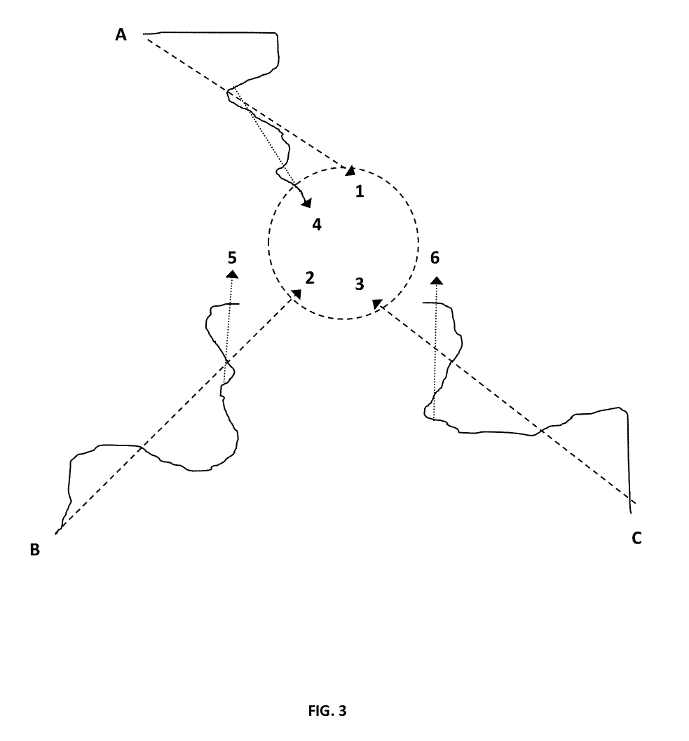

At step 220, the method determines vectors for movement of entities over a future time period based on the received tracking data. For example, step 220 may determine a vector for movement of an entity represented in the received tracking data based on the time and location data of the entity over the past time period, and may extrapolate the determined vector over a future time period. A plurality of vectors may be determined, based on tracking data over a corresponding plurality of different time periods, such as short, medium and long term time periods. In this case, the method 200 may be performed separately for each time period. As the skilled person will appreciate, a vector determined based on tracking data over a short time period, such as data from the past 5 minutes, may be more precise in terms of ultimate location (since speed and location are unlikely to change significantly) but may lead to an inaccurate prediction of future movement in terms of direction (since the direction of travel may change frequently due to road layouts and the like). In contrast, a vector determined based on tracking data over a long time period, such as data from the past 60 minutes, may lead to a more accurate prediction (relative to a short/medium time period) of future movement in terms of direction (since the general direction of travel will be accurately reflected by the tracking data) but may be less precise (relative to a short/medium time period) in terms of ultimate location. A vector determined based on tracking data over a medium time period, such as data from the past 20 minutes, may lead to a prediction of future movement in terms of direction of greater or lesser accuracy relative to a short or long time period, respectively, but may be less or more precise in terms of ultimate location relative to a short or long time period, respectively. Thus, the use of multiple vectors in order to balance these conflicting factors may be used as required. A suitable method for step 220 of determining a vector for movement of an entity over a future time period is described below with reference to FIGS. 3-9. As the skilled person will recognize, other suitable methods are possible and contemplated by the present invention.

At step 230, the method selects one or more vectors of interest from the vectors determined in step 220, based on a user-defined target selection. For example, as described above, the target selection data may define one or more groups of target entities, and step 230 may select, as vectors of interest, vectors relating to the target entities. Alternatively, or in addition, the target selection data may include other constraints, such as location and time constraints, and step 230 may select, as vectors of interest, vectors satisfying such constraints.

At step 240, the method processes each vector of interest, and, in particular, determines whether the vector of interest is converging in time and space with another vector of interest (e.g., a vector of interest relating to the same target group). In example implementations of the present invention, step 240 may determine whether a vector of interest relating to an entity associated with a first individual in a user-specified target group is converging in time and space with another vector of interest relating to an entity associated with a second individual in the same target group.

At step 250, the method predicts potential meetings of two or more target individuals (e.g., individuals of the same target group), based on the convergence of vectors of interest associated with those target individuals determined in step 240. In example implementations of the present invention, step 250 may combine instances of a determined convergence of two or more pairs of vectors of interest where the two or more pairs of vectors of interest relate to the same meeting so as to predict a single or fused meeting, as described above in relation of fusion subsystem 16. Potential meetings predicted in step 250 may be output as predicted meeting data in a notification forming an alert to a user.

At optional step 260, the method determines whether updated tracking data has been received and/or whether additional processing is required. If step 260 determines that updated tracking data has been received and/or additional processing should be performed, the method returns to step 220, which may use updated tracking data to determine updated vectors for movement of entities over the future time period. Additional processing may then continue with steps 230 through 260. Such additional processing, which may be performed a predefined number of times or over a predefined time period, may be required to verify, or meet a desired certainty for, the prediction of meetings. If step 260 determines that no updated tracking data has been received, or additional processing is not required or is complete, then the method ends at step 265.

As the skilled person will appreciate, various modifications may be made to the method 200 of FIG. 2 according to design requirements. For example, the tracking data received at step 210 may be filtered according to the target selection data comprising constraints for entities, time and/or location etc. In this case, step 220 may only determine vectors of interest using the received tracking data, and so step 230 may be omitted. Moreover, the vectors of interest may be selected entirely based on non-entity related constraints, for example if the user wishes to identify predicted meetings or events involving unknown individuals at a particular time and/or location.

FIGS. 3 to 9 are schematic diagrams illustrating techniques for detecting convergence according to example implementations of the present invention.

FIG. 3 is a schematic diagram illustrating paths showing the movement of three entities associated with individuals A, B and C, which are converging upon a location (depicted by a circle). In the illustrated example, A is coming from northwest, B from southwest, and C from southeast following actual paths illustrated as solid wandering lines, which may be derived from received tracking data. Long dashed lines (pointing to locations 1, 2, 3) show vectors determined from tracking data over a preceding long time period (e.g., for the full trip shown or from a defined starting time, such as the previous 60 minutes). Short dashed lines (pointing to locations 4, 5, 6) show vectors determined from just the tracking data over a preceding short time period (e.g., for the most recent legs or from another, more recent, defined starting time, such as the previous 15 minutes).

As can be seen in FIG. 3, the vectors determined for entities A, B and C over the long time period (indicated in long dashed lines) suggests that they are converging on the location indicated by the circle. However, the vectors determined for the same entities over the short time period (indicated by dotted lines) suggests that convergence may not occur. Accordingly, as indicated above, the method of determining whether vectors are converging on a location in time and space may consider vectors over multiple timescales and determine, for each timescale, whether two or more vectors are converging on a location in space and time.

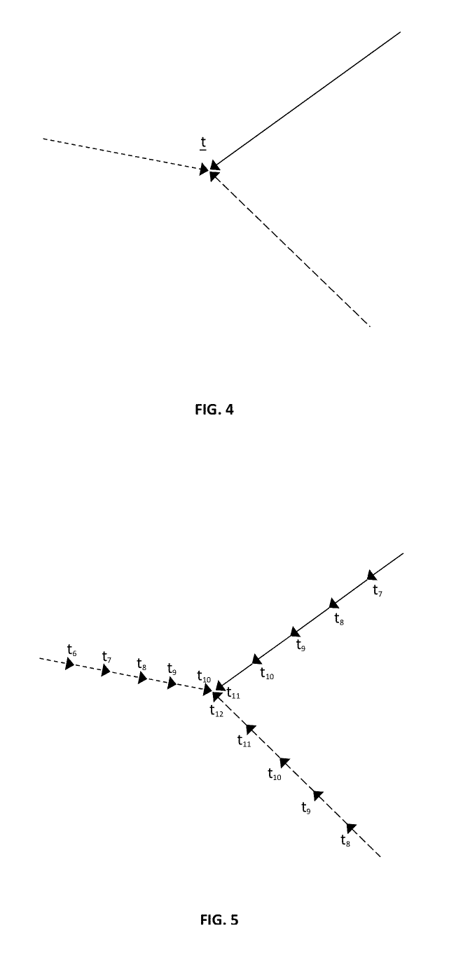

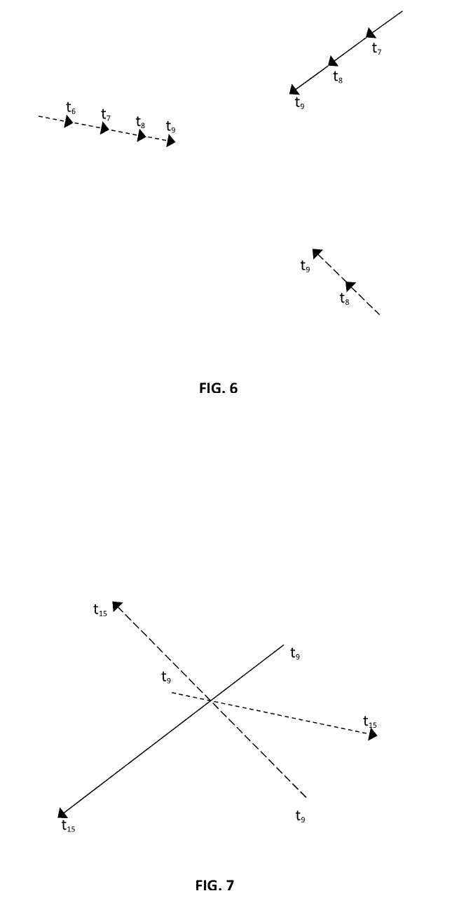

FIG. 4 illustrates a scenario where three vectors, determined over the same time period for three entities (e.g., individuals participating in a meeting or associated mobile devices or vehicles), converge perfectly in time (t) and space (x, y). In reality, participants will not arrive at the meeting point or location (x, y) at exactly the same time. FIG. 5 shows the three vectors of FIG. 4 with times of the tracking data indicated (between times t₆ and t₁₂). FIG. 5 shows that the three entities all arrive at the meeting point (x, y) at different times, t₁₀, t₁₁ and t₁₂, respectively. As the skilled person will appreciate, FIGS. 4 and 5 show vectors that are determined based on tracking data received up to and including the time t₁₂ when the meeting between the three individuals can start. However, since tracking data is only available for a past time period, tracking data close to the starting time of the meeting may not be available, in practice. FIG. 6 shows an example of vectors based on tracking data that may be available prior to the starting time of the meeting shown in FIG. 5, and, in particular, vectors based on tracking data available for the three entities for the period t₆ to t₉. Using the tracking data for the time period between times t₈ and t₉, vectors for a future time period may be determined (i.e., predicted) for each of the three entities. For example, vectors for the future time period may be determined by extrapolating the vector for each entity for the time period t₈ to t₉ to time t₁₅ as shown in FIG. 7. In example implementations of the present invention, the above described technique may be used in step 220 of the method 200 of FIG. 2 as described above. The following description relates to techniques for determining whether a vector is converging with at least one other vector, which may be used in step 240 of the method 200 of FIG. 2 in example implementations of the present invention.

A first example method may be used to determine whether a pair of vectors are converging in time and space. For each pair of vectors, the method calculates the point in time at which the two entities are closest together in space (or location) as follows:

Assume traveler 1 starts at a location (x1, y1) and has a speed of (a1, b1). This means that after one second traveler 1 will be at (x1+a1, y1+b1), and after t seconds at (x1+a1·t, y1+b1·t). Similarly, assume traveler 2 starts at a location (x2, y2) and has a speed of (a2, b2).

The distance d(t) between the two travelers 1 and 2 is minimal if the square d(t)² of the distance d(t) is minimal, wherein d(t)² is defined by:

$$\begin{matrix}{d ( t )}^{2} = {( x 1 + a 1 \cdot t - x 2 - a 2 \cdot t )}^{2} + \\ {( y 1 + b 1 \cdot t - y 2 - b 2 \cdot t )}^{2} \\ = {( x + a \cdot t )}^{2} + {( y + b \cdot t )}^{2}\end{matrix} \qquad ( Equation 1 )$$

where:

x=x1−x2

y=y1−y2

a=a1−a2

b=b1−b2

At the minimum d(t)², the derivative of d(t)² with respect to t is 0, as defined by:

2a(x+a t_{closest})+2b(y+b t_{closest})=0 (Equation 2)

Assuming a²+b²≠0 (i.e., non null speed), solving Equation 2 for t yields:

t_{closest}=−(ax+by)/(a²+b²) (Equation 3)

The point in time at which the travelers 1 and 2 are closest (t_{closest}), as determined using Equation 3, may be used, together with the respective starting coordinates and speeds of travelers 1 and 2 as set out above, to determine the corresponding coordinates (x, y) of travelers 1 and 2 at time t_{closest}. The coordinates at time t_{closest} may be used, in turn, to determine the minimum distance d between the travelers 1 and 2 by setting t=t_{closest} in Equation 1 and solving Equation 1 for d(t_{closest}) by computing the square root of d(t_{closest})², and thus whether or not there is convergence.

Thus, the first example method derives the time and corresponding coordinates at which the two vectors are closest together, which takes into account both time and space (or location). It should be noted that the closest point in time and space, which is used to identify convergence, is not necessarily the point at which the two vectors cross. This is shown in FIG. 8, where the position of t_{closest} is indicated on the vector of each of the travelers 1 and 2 and a line between the positions (i.e., coordinates) at t_{closest} indicates the minimum distance between the travelers 1 and 2.

In example implementations of the present invention, a threshold for distance d may be used to determine whether the vectors are converging. For example, a maximum distance d between the vectors may be predefined as a threshold by a user, and the vectors may be determined to be converging if the distance at t_{closest} is less than or equal to the threshold. The user may select the threshold based on requirements such as the certainty and accuracy required or the processing resources and/or time available.

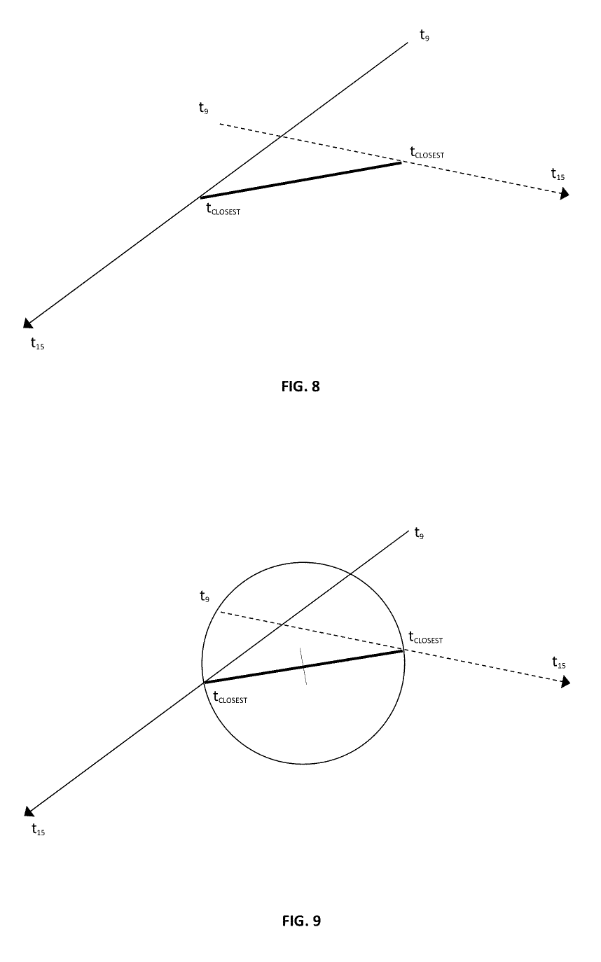

In other example implementations, additional tracking data may be used to determine whether there is convergence or determine a certainty of the determination. Moreover, the method may optionally use the positions at time t_{closest} to generate a circle (i.e., with the positions on the circumference of the circle so that the center of the circle is at the midpoint between the two positions at t_{closest}), as shown in FIG. 9. The method may update the circle as new tracking data is received to determine whether the radius of the circle is increasing or decreasing. A decrease in the size (e.g., radius) of the circle may be used to further indicate that the vectors are converging (thus decreasing uncertainty) whilst an increase may indicate that the tracks are diverging (i.e., thus increasing uncertainty).

A second example method may be used to determine whether three or more vectors are converging in time and space. For each pair of vectors, the method calculates the point in time at which the two entities are closest together in space (or location) as follows:

Assume there are k travelers, defined by starting position (xi, yi) and speed (ai, bi) where i ranges over k travelers, wherein k is at least 2 generally, and is at least 3 in one embodiment. The square dij(t)² of the distance dij(t) between travelers i and j is defined as follows:

dij(t)²=(xij+aij·t)²+(yij+bij·t)² (Equation 4)

where:

xij=xi−xj,

yij=yi−yj

aij=ai−aj

bij=bi−bj

As with the first example method, the sum of these square distances should be minimal; i.e., minimize d(t)²=Σ (i, j st i<j) dij(t)², wherein Σ (i, j st i<j) is a mathematical operator defined as a summation (Σ) over i and j subject to i<j. The preceding mathematical operator operates on dij(t)² in the preceding equation for d(t)². Since the second order derivative of d(t)² is positive, d(t)² is minimal when the first order derivative of d(t)² with respect to t is 0, as follows:

Σ(i,j st i<j)[2aij(xij+aij·t)+2bij(yij+bij·t)]=0 (Equation 5)

Solving Equation 5 for t yields

t_closest=−Σ(i,j st i<j)(aij xij+bij yij)/Σ(i,j st i<j)(aij²+bij²) (Equation 6)

Using equation 6, the time at which the k travelers are mutually closest (t_closest) is determined, and, in turn, used to determine the location of each traveler at t_closest as follows:

(xij+aij t_closest,yij+bij t_closest) (Equation 7)

As with the first example method, the positions of the travelers at time t_closest may be used to determine whether there is convergence. For example, the positions of the k travelers at time t_closest may be used to define an area, the size of which indicates whether there is convergence. Thus, in example implementations, the method may draw one or more circles, using the technique described above with reference to FIG. 9 or otherwise, based on the determined positions of the k travelers, or k traveler pairs, at time t_closest, and the area defined by the smallest circle compared with a threshold area corresponding to a maximum area indicative of convergence. Alternatively, the sum of the squares of the distances between all pairs of the positions of the k travelers at time t_closest may be compared with a threshold to determine whether there is convergence.

For ease of understanding, the vectors described above in relation to the first and second example methods are in two-dimensional space (x, y). As the skilled person will appreciate, the example methods may be extended to vectors in three-dimensional space (x, y, z), so as to include an altitude in addition to latitude and longitude (or equivalent). In particular, whilst the use of vectors in two-dimensional space are generally sufficient to identify a meeting location for scenarios involving typical land-based meetings, the use of vectors in three-dimensional space may be beneficial for scenarios involving air and sea (including sub-sea) based meetings, or meetings above or below ground level in buildings or other meeting venues.

As the skilled person will appreciate, the first and second example methods described above are based on first determining a time at which the travelers are closest, determining a distance between the travelers at the determined time, and using a threshold distance to determine convergence. Other example methods may be based on first determining a location at which the travelers are closest, determining a time separation between the travelers arriving at the determined location, and using a threshold time separation to determine convergence.

As the skilled person will further appreciate, the first and second example methods involve straightforward, and therefore computationally efficient, processing, thereby minimizing processing requirements, while enabling prediction based on both time and space dimensions for improved accuracy and/or certainty. As described above, if four members (A-D) of the same organization are actually meeting, then the vector analysis subsystem 14 of FIG. 1 may use the first method to identify convergence of at least six separate groups of two individuals (EntityA-EntityB, EntityA-EntityC, EntityA-EntityD, EntityB-EntityC, EntityB-EntityD, EntityC-EntityD). In this case, the fusion subsystem 16 may be used to identify a single predicted meeting with improved accuracy and/or certainty. Alternatively, the vector analysis subsystem 14 of FIG. 1 may use the second method to directly identify convergence of the four individuals with improved accuracy and/or certainty, without the need for additional processing by the above described fusion subsystem 16 of FIG. 1.

As well as predicting meetings between individuals, which may include so-called “live drops” where individuals meet and exchange objects or information, methods according to the present invention may be used to predict so called “dead drops”. In particular, a dead drop is a situation where one individual leaves an object or information at a particular location at a particular time and another individual collects the object or information from the location at a later time. The time lapse between the time when the two individuals are at the dead drop location is may be within a relatively short time period (e.g., minutes or hours) or a relatively long time period (e.g., weeks or months) and may depend on the dead drop location and/or other factors. Accordingly, the methods according to the present invention may be used to predict dead drop scenarios based on predicted convergence of vectors at a particular location within a suitably defined time window.

As described above, methods according to the present invention predict potential meetings and may provide corresponding meeting prediction data in a notification to a user. The user may then choose an appropriate course of action for responding to the notification. For example, the user may monitor tracking data for the relevant entities associated with the predicted meeting in real time and record data of any actual meeting. Such data may include the time at which each entity arrives at the location, the start time, the end time and the duration of the meeting and the identities of the individuals in attendance. As the skilled person will appreciate, the user may require the meeting prediction system 10 to automatically monitor tracking data associated with all predicted meetings. In this case, the user may specify such as requirement for a particular target group when inputting data into target selection subsystem 12, or may indicate a requirement to monitor tracking data subsequently, for example in response to receiving a notification as an alert.

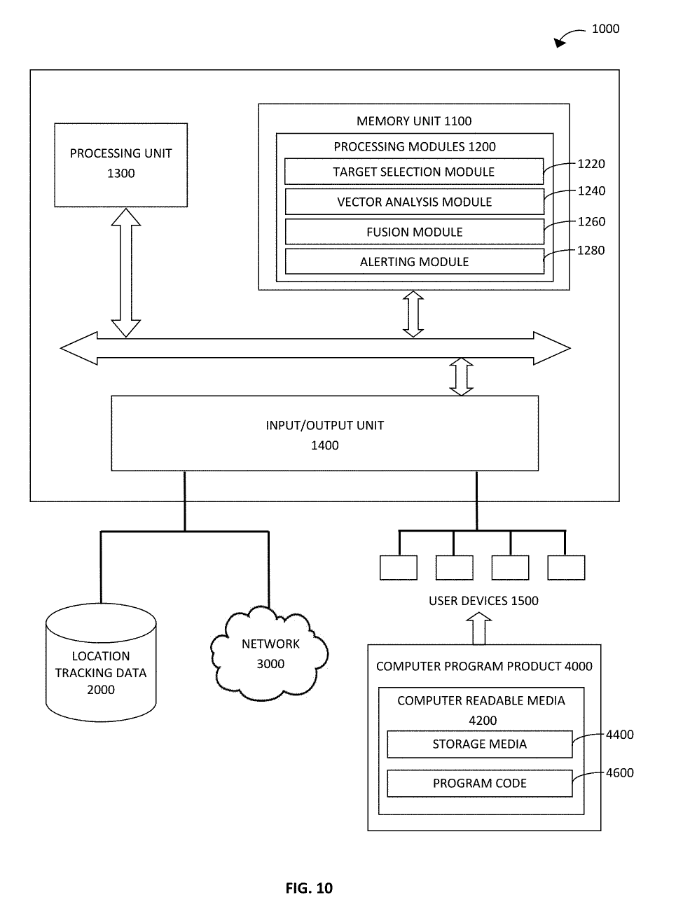

FIG. 10 is a block diagram of a system 1000 for processing data and predicting an event, such as a meeting, according to an example implementation of the present invention. The system 1000 may be used to process tracking data and predict meetings between individuals, including target individuals, at a geographical location at a future time, such as in the meeting prediction system 10 of FIG. 1.

System 1000 includes a memory unit 1100 for storing processing modules 1200 associated with predicting an event, one or more processing units 1300 for processing data, and, in particular, for executing program code of the processing modules 1200, and an input/output (I/O) unit 1400 for providing data to and from user devices 1500 providing a user interface to the system 1000. The user devices 1500 may include a keyboard, mouse, display, touch screen, touch pad or any other suitable device for enabling the user to enter data into and/or receive data from system 1000. In addition, the user devices 1500 may include mobile devices capable of accessing the system 1000, either directly or over a network. In addition, as shown in FIG. 10, I/O unit 1400 is in data communication with a location tracking data warehouse/database 2000 and, optionally, a data communications network 3000.

In accordance with example implementations of the present invention, one or more memory units 1100 includes processing modules 1200 including a target selection module 1220 for receiving and processing data relating to selections of target entities, including target entities, individuals, times, locations and other target constraints, by a user via one or more of the user devices 1500. In example implementations, target selection module 1220 enables the user to specify or select groups of entities, including pairs of entities relating to target individuals as described above.

In accordance with example implementations of the present invention, processing modules 1200 further include a vector analysis module 1240 for receiving and processing tracking data received from an external data source via input/output unit 1400 based on the user defined target entities. For example, vector analysis module 1240 may receive and process tracking data and target selection data as described above with reference to FIG. 2 and/or FIGS. 3-9. Vector analysis module 1240 may output predicted event data relating to target entities and/or target groups in accordance with target constraints specified in the target selection data. In example implementations of the present invention, processing modules 1200 further include fusion module 1260 for combining event prediction outputs of vector analysis module 1240 relating to the same predicted event, and alerting module 1280 for generating and providing a user with notifications as alerts via user devices 1500, as described above.

The one or more memory units 1100 may further include random access memory (RAM) and/or read only memory (ROM).

In example implementations of the present invention, a computer program product 4000 may be provided, as shown in FIG. 10. The computer program product 4000 may include one or more computer readable media 4200 having one or more hardware storage media or devices 4400 and program instructions 4600 (i.e., program code) and/or data embodied therein. The program instructions 4600 may be loaded onto a memory unit 1100 of system 1000 via I/O unit 1400. The program instructions 4600 may comprise the above-described processing modules 1200, including vector analysis module 1240 of system 1000. The program instructions 4600 may be executable by the processing unit 1300 of system 1000 to perform event prediction as described above with reference to FIG. 2 and/or FIGS. 3-9.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A computer program product of the present invention comprises one or more computer readable hardware storage devices having computer readable program code stored therein, said program code executable by one or more processors to implement the methods of the present invention.

A computer system of the present invention comprises one or more processors, one or more memories, and one or more computer readable hardware storage devices, said one or more hardware storage device containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

What is claimed is:

1. A method, said method comprising:
receiving, by one or more processors of a computer system, tracking data relating to movement of a plurality of entities associated with individuals over a past time period;
determining, by the one or more processors, a vector for predicted movement of each entity of the plurality of entities over a future time period based on at least part of the received tracking data;
determining, by the one or more processors, whether a first vector for predicted movement of an entity associated with a first individual is converging in time and space with a second vector for predicted movement of an entity associated with a second individual, and
predicting, by the one or more processors, an event involving the first and second individuals in response to determining a convergence of the first and second vectors.

2. The method of claim 1, wherein the tracking data comprises time and location data for an entity of the plurality of entities.

3. The method of claim 1, wherein a vector for predicted movement of an entity of the plurality of entities over a future time period is determined by extrapolating a vector representing past movement of the entity determined using tracking data over a predefined preceding time period of the past time period.

4. The method of claim 1, wherein a vector for predicted movement of an entity of the plurality of entities over a future time period defines a vector location with respect to time.

5. The method of claim 1, said method further comprising:
receiving, by the one or more processors, a constraint of the tracking data, said constraint relating to an entity of the plurality of entities, an individual, a location, or a time;
determining, by the one or more processors, a vector of interest for predicted movement of entities of the plurality of entities over a future time period based on at least part of the received tracking data and the received constraint;
determining, by the one or more processors, whether a first vector for predicted movement of a first entity of the plurality of entities associated with a first individual is converging in time and space with a second vector for predicted movement of a second entity of the plurality of entities associated with a second individual, and
predicting, by the one or more processors, a meeting between the first and second individuals in response to detecting a convergence of the first and second vectors, wherein the predicted event is the predicted meeting.

6. The method of claim 5, wherein said determining whether the first vector is converging in time and space with the second vector for predicted movement of an entity associated with second individual comprises:
determining a time at which a location of the first vector is closest to a location of the second vector;
determining the first and second vector locations at the determined time;
determining a distance between the first and second vector locations at the determined time;
comparing the determined distance between the first and second vector locations with a predefined threshold, and
determining convergence of the first and second vectors based on a result of said comparing.

7. The method of claim 6, wherein, the first vector starts at a first location (x1, y1) and has a first speed (a1, b1) and the second vector starts at a second location (x2, y2) and has a second speed (a2, b2), and wherein said method comprises determining a time at which the first vector is closest to the second vector comprises via:
determining a function d(t)² of time (t) expressed as a square of the distance d(t) between the first vector and the second vector locations at time t;
determining a derivative of the function with respect to time;
determining a time (t_{closest}) at which the derivative is equal to zero; and
using the determined time at which the derivative is equal to zero as the time at which the first vector location is closest to the second vector location.

8. The method of claim 7, wherein
$$\begin{matrix}{d ( t )}^{2} = {( x 1 + a 1 \cdot t - x 2 - a 2 \cdot t )}^{2} + \\ {( y 1 + b 1 \cdot t - y 2 - b 2 \cdot t )}^{2} \\ = {( x + a \cdot t )}^{2} + {( y + b \cdot t )}^{2}\end{matrix} \qquad ( Equation 1 )$$
where:
x=x1−x2
y=y1−y2
a=a1−a2
b=b1−b2,
wherein a²+b²≠0, and
wherein said determining the time (t_{closest}) at which the derivative is equal to zero utilizes Equations 2 and 3:
2a(x+a·t_{closest})+2b(y+b·t_{closest})=0 (Equation 2)
t_{closest}=−(ax+by)/(a²+b²) (Equation 3).

9. The method of claim 1, said method further comprising:
determining whether multiple vectors for predicted movement of entities associated with three or more individuals are converging in time and space.

10. The method of claim 9, wherein said determining whether multiple vectors for predicted movement of entities associated with three or more individuals are converging in time and space comprises:
determining a time at which the multiple vectors are closest in distance to each other;
determining a vector location for each of the multiple vectors at the determined time;
determining a minimum size of an area encompassing each of the multiple vector locations at the determined time;
comparing the determined size of the area encompassing the multiple vector locations with a predefined threshold, and
determining convergence of the vectors based on a result of said comparing.

11. The method of claim 10, wherein, when the multiple vectors relate to k entities, each entity having a starting location (xi, yi) and a speed (ai, bi), wherein k is at least 2, wherein said determining a time at which the multiple vectors are closest to each other comprises:
determining a function of the square of the distance between each pair of two entities with respect to time;
determining a derivative with respect to time of the sum of the functions for the multiple entities;
determining a time at which the derivative is equal to zero, and
using the determined time at which the derivative is equal to zero as the time at which the multiple vector locations are closest.

12. The method of claim 11, wherein k is at least 3, said method comprising:
determining, by the one or more processors, a function d(t)² of the square dij(t)² of the distance dij(t) between multiple pairs of two entities (i, j) at time (t) using equation 4:
dij(t)²=(xij+aij·t)²+(yij+bij·t)² (Equation 4)
where:
xij=xi−xj,
yij=yi−yj
aij=ai−aj
bij=bi−bj, and
determining, by the one or more processors, the time (t_closest) at which the first order derivative with respect to time of the the function d(t)² is equal to zero using Equations 5 and 6:
Σ(i,j st i<j)[2aij(xij+aij·t)+2bij(yij+bij·t)]=0 (Equation 5)
t_closest=−Σ(i,j st i<j)(aij xij+bij yij)/Σ(i,j st i<j)(aij²+bij²) (Equation 6)

13. The method of claim 1, wherein said determining whether a first vector for predicted movement of an entity associated with a first individual is converging in time and space with a second vector for predicted movement of an entity associated with a second individual comprises:
determining a vector location at which the first and second vectors are closest in time to each other;
determining a first time at which the first vector is at the determined vector location and a second time at which the second vector is at the determined vector location;
determining a time difference between the first time and the second time;
comparing the determined time difference with a predefined threshold, and
determining convergence of the first and second vectors based on a result of said comparing.

14. A computer program product, comprising one or more computer readable hardware storage devices having computer readable program code stored therein, said program code containing instructions executable by one or more processors of a computer system to implement a method, said method comprising:
receiving, by the one or more processors, tracking data relating to movement of a plurality of entities associated with individuals over a past time period;
determining, by the one or more processors, a vector for predicted movement of each entity of the plurality of entities over a future time period based on at least part of the received tracking data;
determining, by the one or more processors, whether a first vector for predicted movement of an entity associated with a first individual is converging in time and space with a second vector for predicted movement of an entity associated with a second individual, and
predicting, by the one or more processors, an event involving the first and second individuals in response to determining a convergence of the first and second vectors.

15. The computer program product of claim 14, wherein the tracking data comprises time and location data for an entity of the plurality of entities.

16. The computer program product of claim 14, wherein a vector for predicted movement of an entity of the plurality of entities over a future time period is determined by extrapolating a vector representing past movement of the entity determined using tracking data over a predefined preceding time period of the past time period.

17. The computer program product of claim 14, wherein a vector for predicted movement of an entity of the plurality of entities over a future time period defines a vector location with respect to time.

18. A computer system, comprising one or more processors, one or more memories, and one or more computer readable hardware storage devices, said one or more hardware storage device containing program code executable by the one or more processors via the one or more memories to implement a method, said method comprising:
receiving, by the one or more processors, tracking data relating to movement of a plurality of entities associated with individuals over a past time period;
determining, by the one or more processors, a vector for predicted movement of each entity of the plurality of entities over a future time period based on at least part of the received tracking data;
determining, by the one or more processors, whether a first vector for predicted movement of an entity associated with a first individual is converging in time and space with a second vector for predicted movement of an entity associated with a second individual, and
predicting, by the one or more processors, an event involving the first and second individuals in response to determining a convergence of the first and second vectors.

19. The computer system of claim 18, wherein the tracking data comprises time and location data for an entity of the plurality of entities.

20. The computer system of claim 18, wherein a vector for predicted movement of an entity of the plurality of entities over a future time period is determined by extrapolating a vector representing past movement of the entity determined using tracking data over a predefined preceding time period of the past time period.
